(19) United States
(12) Patent Application Publication
(10) Pub. No.: US 2006/0293467 A1
(43) Pub. Date: Dec. 28, 2006

(54) Polymer mixture and method for production thereof

(76) Inventors: Atsuro Yoneda, Osaka (JP); Shigeru Yamaguchi, Osaka (JP)

Correspondence Address: FISH & RICHARDSON PC, P.O. BOX 1022, MINNEAPOLIS, MN, 55440-1022, US

(21) Appl. No.: 10/555,501

(22) PCT Filed: Apr. 30, 2004
(86) PCT No.: PCT/JP04/06314

§ 371 Date: Nov. 3, 2005

(30) Foreign Application Priority Data
May 8, 2003 (JP) 2003130361

(51) Int. Cl. C08F 283/06; C08L 71/00

(52) U.S. Cl. 525/404

(57) ABSTRACT

A method for producing a polymer mixture by polymerizing a (meth)acrylic acid type monomer in the presence of a compound possessing a polyalkylene glycol structure, wherein the amount of water for initial charging is less that 90 parts by mass based on 100 parts bymass of the compound possessing the polyalkylkyleneglycol structure and the amount of water existing at the time of completion of the addition of the (meth)acrylic acid type monomer is in the range of 1-100,000 parts by mass based on 100 parts by mass of the compound possessing the polyalkylene glycol structure is provided. The produced polymer mixture excels in the preservation stability.

### TECHNICAL FIELD

This invention relates to a polymer mixture containing a polymer possessing a polyalkylene glycol structure and a graft polymer comprising a branch polymer formed of a (meth)acrylic acid type monomer joined to the polymer first mentioned above. The polymer mixture of this invention is suitable for compounding a detergent, a scale preventing agent, and a dispersing agent.

### BACKGROUND ART

It is known that a detergent, when combined with a (meth)acrylic acid type monomer, acquires enhanced detergency. It is also known that a detergent, when combined with a compound possessing a polyalkylene glycol structure, enjoys an exalted efficiency in the anti-soil redeposition.

The polymer formed of a (meth)acrylic acid type monomer (hereinafter occasionally referred to as “a (meth)acrylic acid type polymer”) and a compound possessing a polyalkylene glycol structure (hereinafter occasionally referred to as “a PAG compound”), however, do not intermingle homogeneously. In the production of a detergent comprising a (meth)acrylic acid type polymer and a PAG compound, therefore, it is necessary that they be kept stored in separate tanks and taken out of the tanks independently and put to use in the production. The procedure of this sort, however, entails an addition to the equipment cost.

Thus, the desirability of perfecting a means to homogenize a composition containing both the (meth)acrylic acid type polymer and the PAG compound and enhance the preservation stability of the composition has been desired. When the composition containing both the PAG compound and the (meth)acrylic acid type polymer is enabled to be conveyed in one tank from the plant for production of raw materials to the plant for production of a detergent, the conveyance cost can be decreased. Further, the plant producing the detergent is no longer required to prepare two or more tanks. Moreover, the system for supplying raw materials for the reagent is simplified.

As a means of solution to meet this demand, a graft polymer of the (meth)acrylic acid type polymer and the PAG compound is conceivable. For example, a method of graft polymerizing (meth)acrylic acid and a copolymerizable monoethylenically unsaturated monomer to a polyether compound has been proposed (refer to EP639592).

According to the method of EP639592, a homogeneous graft polymer can be produced with a high grafting efficiency in a polymerization reaction system containing substantially no solvent. The composition ratio of the (meth)acrylic acid monomer to the PAG compound, however, cannot be increased because this increase results in increased molecular weight of the polymer and exalting the increased viscosity of the polymer. The product consequently obtained suffers from a poor color tone. Thus, the product of this method does not befit a detergent builder.

A method of forming a biodegradable water-soluble graft polymer by graft polymerizing acrylic acid or its like to the trunk of a polyalkylene oxide, for example, has been proposed (refer, for example, to U.S. Pat. No. 5,318,719).

When a (meth)acrylic acid type monomer is actually graft polymerized in an aqueous solution to the PAG compound by the method of U.S. Pat. No. 5,318,719, a mixed aqueous solution of ungrafted PAG compound, a (meth)acrylic acid type polymer, and a graft polymer is formed. When this mixed aqueous solution is left standing, the PAG compound and the (meth)acrylic acid type polymer are separated and the aqueous solution loses homogeneity. In short, the polymer mixture containing a graft polymer which is produced by the conventional method has been deficient in the preservation stability of the homogeneity.

### DISCLOSURE OF THE INVENTION

The object of the invention is to provide a means to produce a polymer mixture containing a polymer possessing a polyalkylene glycol structure and a graft polymer comprising a branch polymer formed of a (meth)acrylic acid type monomer joined to the polymer first mentioned above, which means enhances the preservation stability of the produced graft polymer-containing polymer mixture.

The further object of the invention is to provide a graft polymer-containing polymer mixture which excels in the preservation stability.

This invention relates to a method for producing a polymer mixture by polymerizing a (meth)acrylic acid type monomer in the presence of a compound possessing a polyalkylene glycol structure, wherein the amount of water for initial charging is less than 90 parts by mass based on 100 parts by mass of the compound possessing the polyalkylene glycol structure; and the amount of water existing at the time of completion of the addition of the (meth)acrylic acid type monomer is in the range of 1-100,000 parts by mass based on 100 parts by mass of the compound possessing the polyalkylene glycol structure. This invention further relates to the polymer mixture obtainable by the method of production mentioned above.

During the polymerization of the (meth)acrylic acid type monomer in the presence of the compound possessing the polyalkylene glycol structure (PAG compound), the preservation stability of the solution containing the polymer mixture is enhanced by controlling the amount of water existing in the polymerization reaction system. Further, by controlling the amount of water present in the polymerization reaction system, it is made possible to enhance the anti-soil redeposition of the polymer mixture. The polymer mixture having high preservation stability contributes to the stabilization of the quality of the product. It further enhances the production freedom of the product using the polymer mixture and permits a cut of the production cost. The polymer mixture which excels in the anti-soil redeposition, when used in compounding a detergent, a scale preventing agent, a dispersing agent, a detergent builder, etc., can contribute to the improvement of the quality of such a product. Here, the concept of a detergent builder embraces detergents for clothing, detergents for various hard surfaces, detergents for automatic dishwasher, detergents for dishes, and detergents for toilet rooms and bathrooms.

### BEST MODE FOR CARRYING OUT THE INVENTION

The first aspect of this invention is directed toward a method for producing a polymer mixture by polymerizing a (meth)acrylic acid type monomer in the presence of a compound possessing a polyalkylene glycol structure, wherein the amount of water for initial charging is less than 90 parts by mass based on 100 parts by mass of the compound possessing the polyalkylene glycol structure; and the amount of water existing at the time of completion of the addition of the (meth)acrylic acid type monomer is in the range of 1-100,000 parts by mass based on 100 parts by mass of the compound possessing the polyalkylene glycol structure.

Hitherto, when (meth)acrylic acid is polymerized in the presence of a PAG compound, the polymerization has actually proceeded under the condition substantially shunning the presence of water or under the condition allowing the presence of a large amount of water. In contrast, in the method of the present invention, the solution containing the produced polymer mixture has the preservation stability thereof and the anti-soil redeposition enhanced by controlling the amount of water added during the production of the polymer mixture. In the present specification, the term “preservation stability” means the degree with which the solution containing the produced graft polymer-containing polymer mixture exists stably during the course of storage and renders separation and degeneration difficult to occur and the term “anti-soil redeposition” means the performance of preventing the defiling component in the solution from being adhered again. When the polymer mixture of this invention is used for compounding a detergent, for example, the anti-soil redeposition constitutes an important factor which brings a serious influence on the quality of the detergent.

In the course of commercial production, the polymer mixture is stored in such a storage facility as a tank and taken out of the tank gradually in an amount needed on each occasion. If the solution containing the polymer mixture is deficient in preservation stability, the portion thereof which is taken out of the tank will have an instable quality and the product from the portion will consequently acquire an instable quality. In the product which meets an exacting demand for stability of quality, the decline of the preservation stability of the solution containing the polymer mixture induces a decrease of the yield. When the preservation stability is high, the product consequently obtained has a stabilized quality. Since the method of the present invention enables the preservation stability of the polymer mixture-containing solution to increase, the quality of product consequently obtained can be kept stable easily.

When the solution containing the polymer mixture has low preservation stability, a certain measure must be adopted so as to prevent the component polymers from being separated mutually. Such measures as curtailing the interval between the time the polymer mixture is produced and the time it is used for compounding a product and keeping the polymer mixture stirred during the storage thereof, for example. These measures, however, boost the cost of production. The polymer mixture-containing solution of this invention excels in preservation stability and, therefore, represses the separation of the solution containing the polymer mixture without adopting any special measure. It is provided, however, that when the polymer mixture produced by the method of this invention is ready for use, a measure intended to retain preservation stability may be adopted as occasion demands. The excellence of the polymer of this invention manifested in the preservation stability of the polymer mixture may be inferred to originate in the graft polymer which is formed in the presence of the prescribed amount of water. Despite this statement, the scope of the invention is not restricted by mechanism.

Further, it is inferred that the anti-soil redeposition of the polymer mixture is exalted when the amount of water existing during the course of production falls in the range defined in the invention. The mechanism of the exaltation of the anti-soil redeposition of the polymer mixture is inferred to originate in the increase of the proportion of the graft polymer contained in the polymer mixture. It is provided, however, that the scope of the invention is not restricted to the graft polymer which has the anti-soil redeposition enhanced by this mechanism.

Now, the “water for initial charging” and the “water at the time of completion of the addition of a (meth)acrylic acid type monomer” which characterize the method of production of this invention will be described below.

The method of the invention defines the amount of water used for initial charging. The term “water for initial charging” as used in this specification means the water which is added to the polymerization reaction system prior to the start of polymerization. When the polymerization is made to proceed by adding a (meth)acrylic acid type monomer and a polymerization initiator dropwise into a liquid containing a PAG compound, for example, the water which is contained by the liquid containing the PAG compound constitutes the “water for initial charging.” The term “polymerization reaction system” means the system in which the polymerization reaction proceeds. When the polymerization proceeds by the dropwise addition of a monomer component to the liquid containing the PAG compound, the liquid containing the PAG compound constitutes the “polymerization reaction system”. When the water for initial charging has been incorporated to a certain degree, the polymerization reaction system is a polymerization reaction solution.

The amount of the water for initial charging is less than 90 parts by mass based on 100 parts by mass of the PAG compound. The lower limit to the amount of the water for initial charging is not particularly restricted. The addition of the water for initial charging may be omitted as occasion demands. The anti-soil redeposition of the polymer mixture to be synthesized may increase by decreasing the amount of the water for initial charging. Further, by decreasing the amount of the water for initial charging, it is made possible to enhance the preservation stability. The amount of the water for initial charging falls preferably in the range of 0-80 parts by mass, more preferably in the range of 0-50 parts by mass based on 100 parts bymass of the PAG compound. When the amount of the water for initial charging to be incorporated falls in the neighborhood of this range, the weight average molecular weight of the polymer contained in the produced polymer mixture may be decreased. The polymer used as a detergent, a scale preventing agent, a dispersing agent, or a detergent builder tends to gain in performance in proportion as the molecular weight decreases. When the amount of the water for initial charging to be incorporation falls in this neighborhood, this incorporation is effective in enhancing the performance. If the amount of the water for initial charging is unduly large, the excess will possibly result in degrading the preservation stability. Thus, the excess ought to be avoided attentively.

The method of the invention defines the amount of the water existing at the time of completion of the addition of the (meth)acrylic acid type monomer in addition to the amount of the water for initial charging. The expression “the amount of the water existing at the time of completion of the addition of the (meth)acrylic acid type monomer” means the amount of the water which exists in the polymerization reaction system at the time of completion of the addition of the (meth)acrylic acid type monomer. When polymerization proceeds in the liquid containing the PAG compound by adding dropwise a (meth)acrylic acid type monomer and a polymerization initiator, for example, the water which is contained in the polymerization reaction solution at the time that the dropping of the (meth)acrylic acid type monomer is completed constitutes “the water existing at the time of completion of the addition of the (meth)acrylic acid type monomer.”

The amount of the water existing at the time of completion of the addition of the (meth)acrylic acid type monomer (hereinafter occasionally stated as “the water at the time of completion of the addition”) is in the range of 1-100,000 parts by mass based on 100 parts by mass of the PAG compound. When the amount of the water at the time of completion of the addition falls in this range, the anti-soil redeposition of the produced polymer mixture is improved. Then, when the amount of the water at the time of completion of the addition falls in this range, the preservation stability is improved. The amount of the water at the time of completion of the addition is preferably in the range of 5-50,000 parts by mass and more preferably in the range of 10-10,000 parts by mass based on 100 parts by mass of the PAG compound.

The compounds to be used in the method of this invention and the conditions of production will be described below.

The polymer mixture of this invention is synthesized by polymerizing a (meth)acrylic acid type monomer in a polymerization reaction system in the presence of a PAG compound. The graft polymer contained in the polymer mixture obtained by the invention has a PAG compound as a trunk polymer and a polymer formed of a (meth)acrylic acid type monomer as a branch polymer.

The PAG compound is not particularly restricted but is only required to possess a polyalkylene glycol structure. The term “polyalkylene glycol structure” means a structure represented by the following general formula (1):
—(O—R)ₙ— (1)
(wherein R denotes an alkylene group and n denotes a number of repetitions). Though the alkylene group does not need to be particularly restricted, methylene group, ethylene group, propylene group, trimethylene group, and cyclohexylene group may be cited as examples. The number denoted by “n” falls generally in the range of 5-200, preferably 5-100, more preferably 7-90, and particularly preferably 10-80. However, n does not need to be restricted to this range.

As concrete examples of the PAG compound, polyalkylene glycols such as polyethylene glycol and polypropylene glycol, copolymers of ethylene oxide and propylene oxide, and ether compounds of polyalkylne glycols may be cited. These PAG compounds are substantially formed of polyalkylene glycols. A component having no polyalkylene glycol structure may be contained in a certain amount in the PAG compound. An adduct obtained from a compound possessing an active hydrogen by the addition of a polyalkylene glycol to the active hydrogen may be cited, for example. That is, the compound resulting from substituting a polyalkylene glycol structure for the active hydrogen of polyethylene imine may be used as a PAG compound. Besides, ester compounds of polyalkylene glycols and polyalkylene glycol adducts of such compounds as isoprenol and allyl alcohol which have an unsaturated double bond may be used as PAG compounds.

A PAG compound may be synthesized based on knowledge to be acquired or a commercially available PAG compound may be adopted. To synthesize a compound which has a polyalkylene glycol structure substituted for the active hydrogen of polyethylene imine, for example, it suffices to polymerize the polyethylene imine of a prescribed amount with a prescribed polyethylene imine. It is permissible, when necessary, to use two or more kinds of PAG compounds.

The molecular weight of the PAG compound is not particularly restricted. The PAG compound may be properly selected in accordance with the structure of the PAG compound and the properties required of the polymer mixture. In consideration of such applications as detergents and scale preventing agents, PAG compounds having weight average molecular weights falling preferably in the range of 500-20,000, more preferably 700-15,000, still more preferably 800-12,000, and particularly preferably 1,000-10,000 are used.

The term “(meth)acrylic acid type monomer” to be used for forming a branch polymer means acrylic acid, methacrylic acid, and salts thereof. As concrete examples of the salts of acrylic acid and methacrylic acid, the salts resulting from neutralizing acrylic acid or methacrylic acid with such alkali components as sodium hydroxide and potassium hydroxide and the salts resulting from neutralizing acrylic acid or methacrylic acid with ammonia or such organic amine as ethanol amine or triethanol amine may be cited.

Other monomer which is copolymerizable with (meth)acrylic acid type monomer may be used when necessary. As such other monomers, compounds which have an ethylenically unsaturated bond are usable. The term “ethylenically unsaturated monomer” refers to a compound formed by substituting the hydrogen atoms of ethylene (CH₂═CH₂). It is permissible to use a salt of an ethylenically unsaturated monomer.

As concrete examples of the ethylenically unsaturated monomer, monoethylenically unsaturated aliphatic monocarboxylic acids, monoethylenically unsaturated aliphatic dicarboxylic acids, and monoethylenically unsaturated compounds possessing a sulfonic acid group may be cited.

The term “monoethylenically unsaturated aliphatic monocarboxylic acid” means an aliphatic hydrocarbon whose substituent for the hydrogen atoms of ethylene has one carboxyl group (—COOH). The monoethylenically unsaturated aliphatic monocarboxylic acids include crotonic acid and “α-hydroxyacrylic acid.

The term “monoethylenically unsaturated aliphatic dicarboxylic acid” means an aliphatic hydrocarbon whose substituent for the hydrogen atoms of ethylene has two carboxylic groups. The monoethylenically unsaturated aliphatic dicarboxylic acids include maleic acid, maleic anhydride, fumaric acid, itaconic acid, and itanonic anhydride. The monoethylenically unsaturated dicarboxylic acid may be in an anhydridized form and may be allowed to form a cyclic structure at the site of anhydridization.

The term “ethylenically unsaturated compound possessing a sulfonic acid group” means a compound whose substituent for the hydrogen atoms of ethylene has one or more sulfonic acid groups. The monoethylenically unsaturated compounds possessing a sulfonic acid group include vinyl sulfonic acid and allyl sulfonic acid.

As concrete examples of the salts of ethyleniclly unsaturated monomer, the salts formed by neutralizing the compounds cited above with an alkali component such as sodium hydroxide or potassium hydroxide and the salts formed by neutralizing the compounds cited above with ammonia or an organic amine such as monoethanol amine or triethanol amine may be cited.

The (meth)acrylic acid type polymer formed as a branch polymer from a (meth)acrylic acid type monomer and, when necessary, from other monomer does not need to have a particular form. The form and the molecular weight of the (meth)acrylic acid type polymer may be properly selected in accordance with the characteristic properties which are required of the polymer mixture. In consideration of the preservation stability and the anti-soil redeposition, the (meth)acrylic acid type polymer contains the repeating unit formed of (meth)acrylic acid type monomer in an amount falling preferably in the range of 5-95 mass % and more preferably 10-90 mass % on the average.

The polymer mixture is obtained by polymerizing a (meth)acrylic acid type monomer in the presence of a PAG compound. The method for producing the polymer mixture is not particularly restricted with the exception of the fact that the amount of the water for initial charging and the amount of water existing at the time of completion of the addition are defined. The polymer mixture may be produced based on the knowledge acquired. A modification which will be specifically described herein below may be applied, when necessary, to the production. Now, one embodiment of the method for production of the polymer mixture will be described below by depicting the component steps thereof sequentially in the order of their occurrence.

First, a PAG compound is prepared in a prescribed amount. The amount of the PAG compound to be used is decided in accordance with the characteristic properties which are expected of the polymer mixture.

A prescribed amount of the water for initial charging is incorporated into a polymerization reaction system containing the PAG compound. This incorporation of the water for initial charging may be omitted as occasion demands. The solvent in the polymerization reaction system is generally water. For the purpose of enhancing the solubility of the monomer in the solvent, an organic solvent may be properly added to the system in an amount incapable of exerting an adverse effect on the polymerization of the monomer. The polymer mixture which is obtained by the method of the invention normally exists in the aqueous solution. It may exist, when necessary, in the mixed solution of water with an organic solvent. As concrete examples of the organic solvent so added, lower alcohols such as methanol and ethanol; amides such as dimethyl formaldehyde; and ethers such as diethyl ether and dioxane may be cited.

The polymerization reaction system may have a heavy metal ion incorporated therein. By having the heavy metal ion incorporated in the polymerization reaction system, it is made possible to decrease the amount of a persulfate or a bisulfite to be incorporated as an initiator in the polymerization reaction system. Persulfates and bisulfites form a cause of impurities. The sulfurous acid gas which is generated in consequence of the decomposition of a bilsulfite incorporated as an initiator may exert an adverse effect on the safety of a worker during the course of polymerization reaction and on the neighboring environment. By having the heavy metal ion incorporated in the polymerization reaction system, therefore, it is made possible to produce a high quality polymer mixture with few impurities. Further, the occurrence of the sulfurous gas is abated and the working atmosphere is improved.

The term “heavy metal” means a metal having a relative density of not less than 4 g/cm³. As concrete examples of the heavy metal, iron, cobalt, manganese, chromium, molybdenum, tungsten, copper, silver, gold, lead, platinum, iridium, osmium, palladium, rhodium, and ruthenium may be cited. It is permissible to use two or more kinds of heavy metal. The polymerization reaction system may contain ions of such a heavy metal. Preferably, the polymerization reaction system contains iron ions. The valency of such heavy metal ions does not need to be particularly restricted. When iron is used as a heavy metal, for example, the iron ions dissolved in the polymerization reaction system may be Fe²⁺ or Fe³⁺ or the combination thereof.

The addition of heavy metal ions can be effected by using a solution which is formed by dissolving a heavy metal compound. The heavy metal compound to be used in this case is decided, depending on the heavy metal ions expected to be contained in the polymerization reaction system. When water is used as the solvent, a heavy metal salt soluble in water is properly used. As concrete examples of the water-soluble heavy metal salt, Mohr's salt [Fe (NH₄)₂(SO₄)₂.6H₂O], ferrous sulfate heptahydrate, ferrous chloride, ferric chloride, and manganese chloride may be cited. As the method of addition of heavy metal ions, initial addition and gradual addition are available and the initial addition is preferably adopted. It is provided, however, that the method of addition of heavy metal ions does not need to be particularly restricted. The term “initial addition” refers to a method of preliminarily adding the whole amount of heavy metal ions to the polymerization reaction system and the term “gradual addition” to a method of gradually adding heavy metal ions along the advance of polymerization reaction.

Though the content of heavy metal ions does not need to be particularly restricted, it is preferably in the range of 0.1-20 ppm, more preferably 0.2-10 ppm, still more preferably 0.3-7 ppm, particularly preferably 0.4-6 ppm, and most preferably 0.5-5 ppm, based on the total mass of the polymerization reaction system at the time of completion of the polymerization reaction. Substantially no impurity is generated as a result of using heavy metal ions because the heavy metal ions added for the purpose of producing the effect of this invention are only in such a small amount as mentioned above. When two or more kinds of heavy metal ions are contained, the total amount of these heavy metal ions is required to fall in the range mentioned above. Incidentally, the term time of completion of the polymerization reactions means the time at which the polymerization reaction in the polymerization reaction system is substantially completed.

If the content of heavy metal ions falls short of 0.1 ppm, the shortage may possibly prevent the effect due to heavy metal ions from being manifested fully satisfactorily. Conversely, if the content of heavy metal ions exceeds 20 ppm, the excess may possibly result in degrading the color tone. When the polymer mixture is used as a detergent builder or a scale preventing agent, the excess may possibly induce an addition to the defilement or an increase in the scale.

Separately, a (meth)acrylic acid type monomer is prepared. The amount of the (meth)acrylic acid type monomer to be used is decided in accordance with the characteristic properties which are expected of the polymermixture. Generally, the (meth)acrylic acid type monomer is used in an amount which falls preferably in the range of 100-0.1 g, more preferably 95-0.05 g, and still more preferably 90-0.1 g based on 1 g of the PAG compound. It is provided, however, that the amounts of the PAG compound and the (meth)acrylic acid type monomer to be used do not need to be particularly restricted to the range mentioned above but are required to be properly adjusted in accordance with the characteristic properties of the (meth)acrylic acid type monomer. When other monomer is additionally used, the amount thereof is preferably required to fall in such a range as to avoid degrading the characteristic properties of the polymer mixture.

The polymerization reaction is executed by supplying the (meth)acrylic acid type monomer and the other component to the polymerization reaction system containing the PAG compound. One of the preferred embodiments is a method of adding dropwise the monomer component formed of the (meth)acrylic acid type monomer, an initiating agent, and other component to the polymerization reaction system. The polymerization reaction is made to proceed by adding dropwise an aqueous solution containing the (meth)acrylic acid type monomer, an aqueous solution containing the initiating agent, and an aqueous solution containing the other component. Though the concentrations of these solutions do not need to be particularly restricted, they are preferably controlled so that the amount of the water existing at the time of completion of the addition of the (meth)acrylic acid type monomer may fall in the prescribed range.

As the initiating agent, persulfates and bisulfites prove advantageous. If the concentration of the (meth)acrylic acid type monomer is unduly high, the excess may possibly result in increasing the molecular weight of the formed graft polymer and suffering the polymerization reaction solution to gel. When a persulfate and a bisulfite are used as initiating agents, the polymer mixture of a low molecular weight can be produced under the conditions of polymerization using a (meth)acrylic acid type monomer of high concentration.

As concrete examples of the persulfate, sodium persulfate, potassium persulfate, and ammonium persulfate may be cited. As concrete examples of the bisulfite, sodium bisulfite, potassium bisulfite, and ammonium bisulfite may be cited. Sulfites and pyrosulfites are available where necessary.

The ratio of addition of a persulfate and a bisulfite is preferably such that the mass of bisulfite falls in the range of 0.5-10 based on the mass of persulfate taken as 1. If the mass of the bisulfite falls short of 0.5 per 1 mass of the persulfate, the shortage will tend to heighten the weight average molecular weight of the polymer contained in the produced polymer mixture. Conversely, if the mass of the bisulfite exceeds 10 per 1 mass of the persulfate, the excess may possibly prevent the effect due to the bisulfite from being proportionately increased. It is provided, however, that the amounts of the persulfate and the bisulfite do not need to be restricted to the range. The specific amounts of the persulfate and the bisulfite to be incorporated is preferably decided in accordance with the purpose of use and the environment of actual use. When the polymer mixture is used as a detergent builder, for example, if the weight average molecular weight thereof is unduly high, the excess may possibly degrade the performance of the polymer mixture. Their amounts to be added, therefore, is preferably decided with due respect paid to preventing the weight average molecular weight from increasing more than necessary.

The amounts of the persulfate and the bisulfite to be incorporated generally fall in the range of 2-20 g per mole of the (meth)acrylic acid type monomer to be used. When the heavy metal ions are included in the polymerization reaction system, the amounts of a persulfate and a bisulfite to be added may be decreased.

As the other component, an alkali component such as sodium hydroxide may be supplied to the polymerization reaction system for the purpose of controlling the degree of neutralization.

The time for the dropwise addition of each of the components falls generally in the range of 60 minutes -420 minutes, preferably in the range of 90 minutes-360 minutes. The (meth)acrylic acid type monomer may be preliminarily incorporated partly or wholly in the reaction system. The time of the dropwise addition may vary for a particular component.

The speed of dropwise addition of each of the components does not need to be particularly restricted. The speed of the dropwise addition may be constant from the start of the addition through the completion thereof. It may be varied when necessary. For the purpose of heightening the efficiency of production of the polymer mixture, it is commendable to control the speeds of addition of the components so that the concentration of the solid component in the polymerization reaction system after the completion of the dropwise addition, namely the concentration of the solid component possibly formed by the polymerization of the monomer may be not less than 40 mass %.

The polymerization temperature falls preferably in the range of 25-200° C., more preferably 50-150° C., and still more preferably 80-120° C. If the polymerization temperature is unduly low, the shortage may possibly result in increasing the weight average molecular weight of the polymer contained in the produced polymer mixture and adding to the amount of impurities to be formed. Further, the consequent elongation of the polymerization time will result in impairing the productivity of the polymer mixture. If the polymerization temperature is unduly high, the excess may possibly result in increasing the amount of impurities to be formed.

The pressure during the course of the polymerization does not need to be particularly restricted. The polymerization may be formed under normal pressure, a decreased pressure, or an increased pressure, whichever fits the occasion best.

When the polymerization is performed under an acidic condition, the polymerization reaction system may be neutralized by proper addition of an alkali component. As concrete examples of the alkali component used for the neutralization, alkali metal hydroxides such as sodium hydroxide and potassium hydroxide; alkaline earth metal hydroxides such as calcium hydroxide and magnesium hydroxide; and organic amines such as ammonia, monoethanol amine, diethanol amine, and triethanol amine may be cited. These alkali components may be used either singly or in the form of a combination of two or more members.

The weight average molecular weight of the polymer contained in the produced polymer mixture cannot be simply defined because it varies with the kind of PAG compound to be used. The weight average molecular weight of the polymer contained in the polymer mixture falls generally in the range of 2,000-100,000, preferably 2,000-50,000, more preferably 2,000-30,000, still more preferably 2,000-20,000, and particularly preferably 4,000-15,000.

The polymer mixture can be produced by the method described above. It is provided, however, that the method of production of the polymer mixture is not restricted to the preceding description. Other component steps may be properly altered so long as the amount of the water for initial charging and the amount of the water existing at the time of completion of the addition in the polymerization reaction system fall in the ranges defined herein. It is permissible to try more efficient polymerization through consultation with such a known technique as Patent Document 1.

The second aspect of this invention is directed toward a polymer mixture obtainable by the method of production described above. The polymer mixture which is produced by the first aspect of this invention excels in the preservation stability and the anti-soil redeposition.

The polymer mixture is usable as a detergent, a scale preventing agent, and a dispersing agent. The solution thereof may allow addition of a base thereto. As concrete examples of the base, monovalent metal salts such as sodium salts and potassium salts; divalent metal salts such as calcium salts, trivalent metal salts such as aluminum salts, and organic amine salts such as ammonium salts, monoethanol amines, and triethanol amines may be cited.

The description of the polymer mixture is identical with that given in the first aspect of this invention and, therefore, will be omitted here.

### EXAMPLES

Polymer mixtures 1-6 were produced by the following methods and were rated for the anti-soil redeposition and preservation stability. The methods of rating for the anti-soil redeposition and preservation stability were as shown below.

(Anti-Soil Redeposition)

(1) A cotton cloth conforming to JIS (Japanese Industrial Standard) L-0803 and secured from Washing Science Society was cut to obtain white cloths each measuring 5 cm×5 cm.

(2) A hard water was prepared by diluting 2.29 g of calcium chloride dihydrate by addition of pure water to a total volume of 13 kg. The hard water and a tap water for rinsing were kept preserved in a constant temperature bath at 25° C.

(3) In a pot with a Terg-o-Tometer set at 25° C., 500 ml of the hard water and 1 g of clay were placed and stirred together at 100 rpm for one minute. Thereafter, 2.5 g of an aqueous polymer solution having a solid component concentration adjusted to 0.6 mass % was placed in the pot and the aqueous polymer solution were stirred at 100 rpm for one minute.

(4) In a pot, 2.5 g of 6% alkylpolyoxyethylene sulfate aqueous solution, 2.5 g of 1% sodium borate aqueous solution, 2.5 g of 1% sodium citrate aqueous solution, and 15 white cloths were placed and stirred at 100 rpm for one minute.

(5) The wet white cloths were drained manually. The white cloths and 1 liter of a tap water prepared at 25 C in advance were placed in a pot and stirred together at 100 rpm for one minute.

(6) The steps (3) to (5) were performed three times.

(7) The white cloths were each overlaid by a patch, ironed to remove wrinkles and dried as well, and subsequently compared visually as to the degree of defilement, which was rated on a three-point scale, wherein ◯ denotes substantial absence of any stain, X denotes presence of copious stain, and Δ denotes an intermediate degree of stain.

(Preservation Stability)

In a constant temperature vessel, 5 g of an aqueous solution containing a polymer mixture and having a solid component concentration adjusted to 40 mass % was left standing at 35° C. for one hour. The solution was rated for preservation stability on a three-point scale, wherein ◯ denotes absence of turbidity, A denotes presence of slight turbidity, and X denotes presence of turbidity. The absence of turbidity indicates that a relevant aqueous solution of polymer was retained uniformly over a long period of time.

### EXAMPLE 1

In a separable flask made of SUS, having an inner volume of 5 liters, and provided with a reflux condenser and a stirrer, 154 g of polyethylene glycol 4000 (hereinafter abbreviated as “PEG4000”; molecular weight 3000) was placed as a compound possessing a polyalkylene glycol structure and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 450.0 g of 80% acrylic acid aqueous solution (hereinafter referred to as “80% AA”) as a (meth)acrylic acid type monomer, (2) 20.8 g of 48% sodium hydroxide aqueous solution (hereinafter abbreviated as “48% NaOH”) intended to control degree of neutralization, (3) 133.3 g of 15% sodium persulfate aqueous solution (hereinafter abbreviated as “15% NaPS”) as a persulfate, and (4) 114.3 g of 35% sodium bisulfite aqueous solution (hereinafter abbreviated as “35% SBS”) as a bisulfite were added dropwise through different dropping nozzles as kept stirred. The dropping time was 180 minutes for 80% AA and 48% NaOH each, 185 minutes for 15% NaPS, and 175 minutes for 35% SBS. The dropping was continuously performed and the speed of dropping of each of the components was fixed throughout the entire duration of dropping.

The amount of water existing at the time of completion of the addition of the aqueous acrylic acid solution was calculated by the following formula:
(Water for initial charging)+(water in AA aqueous solution)+(water in NaOH aqueous solution)+(water in NaPS aqueous solution)+(water in SBS aqueous solution)=0+450×0.2+20.8×0.52+133.3×0.85×180/185+114.3×0.65=0+90.0+10.8+110.2+74.3=285.3 (g).

The amount of water existing at the time of completion of the addition of the (meth)acrylic acid type monomer was 185 parts by mass based on 100 parts by mass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 375 g of 48% NaOH was gradually added dropwise as kept stirred to the polymerization reaction solution to neutralize the polymerization reaction solution. The solid component concentration in the polymerization reaction solution after the neutralization was 55 mass %. The final degree of neutralization of acid in the polymerization solution containing the produced polymer mixture 1 was 95 mol %. The weight average molecular weight of the polymer mixture was 6700.

### COMPARATIVE EXAMPLE 1

A polymerization reaction was made to proceed by following the procedure of Example 1 while charging the separable flask with 165.0 g of deionized water in conjunction with 154 g of PEG4000. The amount of water for initial charging was 107 parts by mass based on 100 parts by mass of a compound possessing polyalkyleneglycol structure. The amount of water existing a the time of completion of the addition of a (meth)acrylic acid type monomer was 292 parts by mass based on 100 parts by mass of the compound possessing the polyalkylene glycol structure.

The solid component concentration in the polymerization reaction solution after neutralization was 48 mass %. The final degree of neutralization of acid in the polymerization reaction solution containing the produced polymer 2 was 95 mol %. The weight average molecular weight of the polymer 2 was 4700.

### EXAMPLE 2

A polymerization reaction was made to proceed by following the procedure of Example 1 while charging the separable flask with 0.0263 g of Fe (NH₄)₂(SO₄)₂.6H₂O (Mohr'S salt) together with 154 g of PEG4000. The amount of water for initial charging was 0 part by mass based on 100 parts by mass of a compound possessing a polyalkylene glycol structure. The amount of water existing at the time of completion of the addition of the (meth)acrylic acid type monomer was 185 parts by mass based on 100 parts by mass of the compound possessing the polyalkylene glycol structure.

The solid component concentration in the polymerization reaction solution after neutralization was 55 mass %. The final degree of neutralization of acid in the polymerization reaction solution containing the produced polymer 3 was 95 mol %. The weight average molecular weight of the polymer 3 was 5700.

### EXAMPLE 3

A polymerization reaction was made to proceed by following the procedure of Example 1 while using a polyethylene glycol monomethyl ether with 25 mol of polyethylene glycol (hereinafter abbreviated as “PGM25”) in the place of PEG4000. The amount of water for initial charging was 0 part by mass based on 100 parts by mass of a compound possessing a polyalkylene glycol structure. The amount of water existing at the time of completion of the addition of the (meth)acrylic acid type monomer was 185 parts by mass based on 100 parts by mass of the compound possessing the polyalkylene glycol structure.

The solid component concentration in the polymerization reaction solution after neutralization was 55 mass %. The final degree of neutralization of acid in the polymerization reaction solution containing the produced polymer 4 was 95 mol %. The weight average molecular weight of the polymer 4 was 4500.

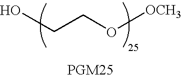

### EXAMPLE 4

A polymerization reaction was made to proceed by following the procedure of Example 1 while using a compound resulting from the addition of 25 mols of ethylene oxide added to each of the amino groups possessed by polyethylene imine having a molecular weight of 600 (hereinafter abbreviated as “PGI25”) in the place of PEG400. The amount of water for initial charging was 0 part by mass based on 100 parts by mass of a compound possessing a polyalkylene glycol structure. The amount of water existing at the time of completion of the addition of the (meth)acrylic acid type monomer was 185 parts by mass based on 100 parts by mass of the compound possessing the polyalkylene glycol structure.

The solid component concentration in the polymerization reaction solution after neutralization was 55 mass %. The final degree of neutralization of acid in the polymerization solution containing the produced polymer 5 was 95 mol %. The weight average molecular weight of the polymer 5 was 14600.

### EXAMPLE 5

In a separable flask made of SUS, having an inner volume of 5 liters, and provided with a reflux condenser and a stirrer, 180.0 g of polyethylene imine (hereinafter abbreviated as “PGI2011) was placed as a compound possessing a polyalkylene glycol structure (PAG compound) together with 0.0217 g of Mohr's salt and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 225.0 g of 80% AA as a (meth)acrylic acid type monomer, (2) 300.0 g of pure water intended to adjust concentration, (3) 66.7 g of 15% NaPS as a persulfate, and (4) 57.1 g of 35% SBS as a bisulfite were added dropwise through different dropping nozzles as kept stirred. The dropping time was 180 minutes for 80% AA and pure water each, 185 minutes for 15% NaPS, and 175 minutes for 35%” SBS. The dropping was continuously performed and the speed of dropping of each of the components was fixed throughout the entire duration of dropping.

The amount of water existing at the time of completion of the addition of the (meth)acrylic acid type monomer was 243 parts by mass based on 100 parts by mass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 202.1 g of 48% NaOH was gradually added dropwise as kept stirred to the polymerization reaction solution to neutralize the polymerization reaction solution. The solid component concentration in the polymerization reaction solution after the neutralization was 45 mass %. The final degree of neutralization of acid in the polymerization solution containing the produced polymer mixture 6 was 95 mol %. The weight average molecular weight of the polymer mixture was 12500.

### EXAMPLE 6

In a separable flask made of SUS, having an inner volume of 5 liters, and provided with a reflux condenser and a stirrer, 141.0 g of PGI20 was placed as a compound possessing a polyalkylene glycol structure (PAG compound) and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 45.0 g of 80% AA as a (meth)acrylic acid type monomer, (2) 13.3 g of 15% NaPS as a persulfate, and (3) 11.4 g of 35% SBS as a bisulfite were added dropwise through different dropping nozzles as kept stirred. The dropping time was 30 minutes for 80% AA and 35% SBS each, and 31 minutes for 15% NaPS. The dropping was continuously performed and the speed of dropping of each of the components was fixed throughout the entire duration of dropping.

The amount of water existing at the time of completion of the addition of the (meth)acrylic acid type monomer was 19 parts bymass based on 100 parts bymass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 39.6 g of 48% NaOH and 150.0 g of pure water were gradually added dropwise as kept stirred to the polymerization reaction solution to neutralize the polymerization reaction solution. The solid component concentration in the polymerization reaction solution after the neutralization was 50 mass %. The final degree of neutralization of acid in the polymerization solution containing the produced polymer mixture 7 was 95 mol %. The weight average molecular weight of the polymer mixture was 12200.

### EXAMPLE 7

In a separable flask made of SUS, having an inner volume of 5 liters, and provided with a reflux condenser and a stirrer, 288.0 g of PGI20 was placed as a compound possessing a polyalkylene glycol structure (PAG compound) together with 0.0157 g of Mohr's salt and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 90.0 g of 80% AA as a (meth)acrylic acid type monomer, (2) 120.0 g of 10% sodium persulfate aqueous solution (hereinafter abbreviated as “10% NaPS”) as a persulfate, and (3) 180.0 g of 10% sodium bisulfite aqueous solution (hereinafter abbreviated as “10% SBS”) as a bisulfite were added dropwise through different dropping nozzles as kept stirred. The dropping time was 180 minutes for 80% AA and 10% SBS each, and 190 minutes for 10% NaPS. The dropping was continuously performed and the speed of dropping of each of the components was fixed throughout the entire duration of dropping.

The amount of water existing at the time of completion of the addition of the (meth)acrylic acid type monomer was 98 parts bymass based on 100 parts bymass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 66.7 g of 48% NaOH was gradually added dropwise as kept stirred to the polymerization reaction solution to neutralize the polymerization reaction solution. The solid component concentration in the polymerization reaction solution after the neutralization was 55 mass %. The final degree of neutralization of acid in the polymerization solution containing the produced polymer mixture 8 was 80 mol %. The weight average molecular weight of the polymer mixture was 10500.

### EXAMPLE 8

In a separable flask made of SUS, having an inner volume of 5 liters, and provided with a reflux condenser and a stirrer, 190.0 g of PGI20 was placed as a compound possessing a polyalkylene glycol structure (PAG compound) and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 12.5 g of 80% AA as a (meth)acrylic acid type monomer, and (2) 18.5 g of 15% NaPS as a persulfate were added dropwise through different dropping nozzles as kept stirred. The dropping time was 60 minutes for 80% AA, and 70 minutes for 15% NaPS. The dropping was continuously performed and the speed of dropping of each of the components was fixed throughout the entire duration of dropping.

The amount of water existing at the time of completion of the addition of the (meth)acrylic acid type monomer was 8 parts by mass based on 100 parts by mass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 11.3 g of 48% NaOH and 225.0 g of pure water were gradually added dropwise as kept stirred to the polymerization reaction solution to neutralize the polymerization reaction solution. The solid component concentration in the polymerization reaction solution after the neutralization was 45 mass %. The final degree of neutralization of acid in the polymerization solution containing the produced polymer mixture 9 was 97 mol %. The weight average molecular weight of the polymer mixture was 9800.

### EXAMPLE 9

In a separable flask made of SUS, having an inner volume of 5 liters, and provided with a reflux condenser and a stirrer, 252.0 g of PGI20 and 36.0 g of polyethylene glycol 2000 (hereinafter abbreviated as “PEG2000”) were placed as a compound possessing a polyalkylene glycol structure (PAG compound) together with 0.0157 g of Mohr's salt and stirred and heated to 90° C. The amount of water for initial charging was 0 g. The amount of water for initial charging, therefore, was 0 part by mass based on the 100 parts by mass of a compound possessing a polyalkylene glycol structure.

Next, into the polymerization reaction system retained at about 90° C., (1) 90.0 g of 80% AA as a (meth)acrylic acid type monomer, (2) 120.0 g of 10% NaPS as a persulfate, and (3) 180.0 g of 10% SBS as a bisulfite were added dropwise through different dropping nozzles as kept stirred. The dropping time was 180 minutes for 80% AA and 10% SBS each, and 190 minutes for 10% NaPS. The dropping was continuously performed and the speed of dropping of each of the components was fixed throughout the entire duration of dropping.

The amount of water existing at the time of completion of the addition of the (meth)acrylic acid type monomer was 98 parts bymass based on 100 parts bymass of a compound possessing a polyalkylene glycol structure.

After the completion of the addition, the polymerization reaction solution was left aging at 90° C. for 30 minutes to complete the polymerization. After the completion of the polymerization, the polymerization reaction solution, which is namely an aqueous solution containing the polymer mixture, was left cooling and 66.7 g of 48% NaOH was gradually added dropwise as kept stirred to the polymerization reaction solution to neutralize the polymerization reaction solution. The solid component concentration in the polymerization reaction solution after the neutralization was 55 mass %. The final degree of neutralization of acid in the polymerization solution containing the produced polymer mixture 10 was 80 mol %. The weight average molecular weight of the polymer mixture was 10000.

### COMPARATIVE EXAMPLE 2

A polymerization reaction was made to proceed by following the procedure of Example 1 while charging the separable flask with 385.0 g of deionized water and 0.0344 g of Mohr's salt together with 154 g of PEG 4000. The amount of water for initial charging was 250 parts by mass based on 100 parts by mass of a compound possessing a polyalkylene glycol structure. The amount of water existing at the time of completion of the addition of the (meth)acrylic acid type monomer was 435 parts by mass based on 100 parts by mass of the compound possessing the polyalkylene glycol structure.

The solid component concentration in the polymerization reaction solution after neutralization was 40 mass %. The final degree of neutralization of acid in the polymerization reaction solution containing the produced polymer 11 was 95 mol %. The weight average molecular weight of the polymer 11 was 3000.

The conditions for synthesis of polymers 1-11 and the rates of these polymers are shown in Table 1. For reference, the anti-soil redeposition of the polysodium acrylate (PSA) having a weight average molecular weight of 6000, PEG4000, and a mixture of PSA and PEG400 are also shown in Table 1 as Referential Examples 1-3.

TABLE 1

| | | (Meth)acrylic | Water for | Water existing | | | | | |
|---|---|---|---|---|---|---|---|---|---|
| | PAG | acid type | initial | at the time of | | | | | |
| | compound | monomer | charging | completion of | | | | | |
| | (Charged | (Charged | (part by | addition (part | Mohr's | Persulfate/ | | anti-soil | Preservation |
| | amount) | amount) | mass) | by mass) | salt | bisulfite | Mw | redeposition | stability |
| Example 1 | PEG4000 | 80% AA | 0 g | 285.3 g | none | yes/yes | 6700 | ∘ | ∘ |
| (Polymer 1) | (154.0 g) | (450.0 g) | (0 part | (185 parts | | | | | |
| | | | by mass) | by mass) | | | | | |
| Comparative | PEG4000 | 80% AA | 165.0 g | 450.3 g | none | yes/yes | 4700 | ∘ | Δ |
| Example 1 | (154.0 g) | (450.0 g) | (107 parts | (292 parts | | | | | |
| (Polymer 2) | | | by mass) | by mass) | | | | | |
| Example 2 | PEG4000 | 80% AA | 0 g | 285.3 g | yes | yes/yes | 5700 | ∘ | ∘ |
| (Polymer 3) | (154.0 g) | (450.0 g) | (0 part | (185 parts | | | | | |
| | | | by mass) | by mass) | | | | | |
| Example 3 | PGM25 | 80% AA | 0 g | 285.3 g | none | yes/yes | 4500 | ∘ | ∘ |
| (Polymer 4) | (154.0 g) | (450.0 g) | (0 part | (185 parts | | | | | |
| | | | by mass) | by mass) | | | | | |
| Example 4 | PGI25 | 80% AA | 0 g | 285.3 g | none | yes/yes | 14600 | ∘ | ∘ |
| (Polymer 5) | (154.0 g) | (450.0 g) | (0 part | (185 parts | | | | | |
| | | | by mass) | by mass) | | | | | |
| Example 5 | PGI20 | 80% AA | 0 g | 437.3 g | yes | yes/yes | 12500 | ∘ | ∘ |
| (Polymer 6) | (180.0 g) | (225.0 g) | (0 part | (243 parts | | | | | |
| | | | by mass) | by mass) | | | | | |
| Example 6 | PGI20 | 80% AA | 0 g | 27.4 g | none | yes/yes | 12200 | ∘ | ∘ |
| (Polymer 7) | (141.0 g) | (45.0 g) | (0 part | (19 parts | | | | | |
| | | | by mass) | by mass) | | | | | |
| Example 7 | PGI20 | 80% AA | 0 g | 282.3 g | yes | yes/yes | 10500 | ∘ | ∘ |
| (Polymer 8) | (288.0 g) | (90.0 g) | (0 part | (98 parts | | | | | |
| | | | by mass) | by mass) | | | | | |
| Example 8 | PGI20 | 80% AA | 0 g | 16.0 g | none | yes/none | 9800 | ∘ | ∘ |
| (Polymer 9) | (190.0 g) | (12.5 g) | (0 part | (8 parts | | | | | |
| | | | by mass) | by mass) | | | | | |
| Example 9 | PGI20(252.0 g) | 80% AA | 0 g | 282.3 g | yes | yes/yes | 10000 | ∘ | ∘ |
| (Polymer 10) | PEG2000(36 g) | (90.0 g) | (0 part | (98 parts | | | | | |
| | | | by mass) | by mass) | | | | | |
| Comparative | PEG4000 | 80% AA | 385.0 g | 670.3 g | yes | yes/yes | 3000 | Δ | x |
| Example 2 | (154.0 g) | (450.0 g) | (250 parts | (435 parts | | | | | |
| (Polymer 11) | | | by mass) | by mass) | | | | | |
| Referential | none | PSA* | | | | | | Δ | |
| Example 1 | | | | | | | | | |
| (PSA) | | | | | | | | | |
| Referential | PEG4000 | none | | | | | | x | |
| Example 2 | | | | | | | | | |
| (PEG) | | | | | | | | | |
| Referential | PEG4000 | PSA* | | | | | | Δ | |
| Example 3 | | | | | | | | | |
| (PEG + PSA) | | | | | | | | | |

*PSA was incorporated as polymer.

As shown in Table 1, the anti-soil redeposition of a produced polymer mixture can be improved by controlling the amount of water for initial charging and the amount of water supplied to the system along the course of supply of the monomer. The polymer mixtures of this invention conspicuously excelled in the anti-soil redeposition as compared with the homopolymer of (meth)acrylic acid type monomer (Referential Example 1), PEG (Referential Example 2), and a simple mixture of these polymers (Referential Example 3). Comparison of working examples of this invention with comparative examples reveals that the anti-soil redeposition of a produced polymer mixture was exalted by controlling the amount of water incorporated in the system. In consideration of the application to a detergent, the excellence in the anti-soil redeposition constitutes a very large effect.

Further by controlling the amount of water incorporated in the system, it was made possible to improve the preservation stability of the solution containing the produced polymer mixture. When the solution containing the polymer mixture possessed high preservation stability, the quality of products using the polymer mixture hardly fluctuates and the cost of production could be lowered.

Further, comparison of Example 1 and Example 3 reveals that the addition of Mohr's salt resulted in lowering the molecular weight of the produced monomer mixture. When the polymer mixture is used for a detergent, the lower molecular weight of the polymer mixture proves advantageous.

### INDUSTRIAL APPLICABILITY

The polymer mixture of this invention excels in the anti-soil redeposition and constitutes an excellent component for incorporation in a detergent. The solution containing the polymer mixture of this invention excels also in the preservation stability. Thus, it enables the produced detergent to acquire stable quality. The exaltation of the preservation stability enhances the production freedom of detergent and allows a further cut in the production cost.

The entire disclosure of Japanese Patent Application No. 2003-130361 filed on May 10, 2001 including specification, claims, drawings, and summary are incorporated herein by reference in its entirety.

1. A method for producing a polymer mixture by polymerizing a (meth)acrylic acid type monomer in the presence of a compound possessing a polyalkylene glycol structure, wherein the amount of water for initial charging is less than 90 parts by mass based on 100 parts by mass of the compound possessing the polyalkylene glycol structure; and the amount of water existing at the time of completion of the addition of the (meth)acrylic acid type monomer is in the range of 1-100,000 parts by mass based on 100 parts by mass of the compound possessing the polyalkylene glycol structure.

2. A method according to claim 1, wherein one or more persulfate and one or more bisulfite are used as polymerization initiator.

3. A polymer mixture obtainable by the method set forth in claim 1.

4. A polymer mixture obtainable by the method set forth in claim 2.
